(19) United States
(12) Patent Application Publication
(10) Pub. No.: US 2005/0215306 A1
(43) Pub. Date: Sep. 29, 2005

(54) Lottery methods and apparatus

(76) Inventors: Michael L. O'Donnell, Sammamish, WA (US); Jonathan E. Peterson, Chicago, IL (US); Paul F. Bugni, Seattle, WA (US)

Correspondence Address: LAW OFFICES OF GREGORY W MORAVAN, 14450 N.E. 29TH PLACE, SUITE 115, BELLEVUE, WA, 98007, US

(21) Appl. No.: 10/812,205

(22) Filed: Mar. 29, 2004

(51) Int. Cl. A63F 13/00

(52) U.S. Cl. 463/17

(57) ABSTRACT

A lottery system and apparatus is disclosed that enables a participating lottery authority to offer within its jurisdiction lottery games originated by other participating lottery authorities. Several lottery player interactive devices are disclosed, such as a web site device, a point of sale device, a wireless device, and a television device; which may be located in a variety of new locations. Several new lottery-related features are disclosed, such as an auto-purchase feature, an auto-deposit of winnings feature, an auto-notification feature, a lottery pool feature, a customized gift pack feature and a prize money beneficiary designation feature.

### BACKGROUND OF THE INVENTION

In general, a lottery is a game of chance in which a drawing of lots is done, and in which prizes are distributed to the winners among players buying a lot.

In a lottery the players may, for example, select a set of chosen numbers for a purchased lottery ticket; and may win a prize based on how many of the set of chosen numbers are the same as the numbers appearing in a set of drawn numbers selected at random by the lottery authority offering the lottery.

Presently, there are dozens of legally sanctioned, government-controlled lotteries operating in the United States and other countries. In the United States, for example, 39 states and the District of Columbia presently operate lotteries.

Players like to participate in lottery games because they are entertaining, low cost relative to other games of chance, and offer a chance for significant financial gain. Most players have a high degree of trust in government-controlled lotteries because they are legal, regulated, audited, conducted openly and fairly, and are fraud-resistant. On the other hand, privately operated lotteries, and lottery services that purport to sell tickets to government-controlled lotteries, may not be legal, and may be subject to a considerable amount of fraud.

Players also appreciate that government-controlled lotteries may provide funding for a variety of governmental operations and programs; and may also provide funding for a variety of non-governmental educational, charitable and other programs and institutions that might not otherwise exist, or that might not otherwise have adequate funding without the lottery.

However, despite its many benefits a government-controlled lottery may have certain limitations. For example, a particular governmental lottery authority may only offer lottery games that are originated by it; it may only be able to lawfully sell lottery tickets to its games to players who are physically present in its particular geographical jurisdiction at the time of ticket purchase; it may only have a limited number of retail outlets or kinds of lottery devices where players may purchase tickets; and it may have only a limited number of features available to players who may wish to participate in a lottery.

For example, a California lottery authority might only permit lottery tickets to be sold to players by authorized retail outlets having attendant-assisted lottery ticket sales devices, such as supermarkets or convenience stores.

In addition, a California lottery authority might only permit players physically present in California to purchase a lottery ticket from it, and even then those players might be permitted to only purchase tickets for lottery games offered by the California lottery authority.

In order to increase its sales of lottery tickets, a California lottery authority might sell tickets to players who are non-residents of California, as long as the players are physically present in California at the time of ticket purchase. However, even then the number of non-resident players who might be in California at the time of ticket purchase is very limited as compared to the number of potential non-resident players in the rest of the U.S. or in the rest of the world who might be interested in purchasing a ticket to a lottery offered by a California lottery authority.

### BRIEF SUMMARY OF THE INVENTION

The lottery method and apparatus of the present invention may address one or more of the above and other limitations of a conventional government-controlled lottery, as will be made apparent to those of ordinary skill in the art in view of all of the disclosures herein. At the same time the present invention may enable a particular lottery authority to maintain control over at least one of: “what” lottery tickets may be sold, “where” they may be sold, “who” may sell them, “when” they may be sold, “how” they may be sold, and “who” may buy them.

One aspect of the present invention may be to provide a method and apparatus that may enable at least two participating lottery authorities who have entered into a lottery agreement to offer to sell within their respective physical jurisdictions lottery tickets to any lottery games originated by each other. A particular lottery authority may participate in such a lottery agreement even though it has not originated any lottery games of its own; in which case it may offer to players within its physical jurisdiction the lottery games originated by the other participating lottery authorities. In any event, this aspect of the present invention may be desirable because, for example, it may increase the number of lottery games that a particular lottery authority may offer, and it may increase the number of potential players for any particular lottery game originated by that particular lottery authority, thereby increasing player interest and increasing that particular lottery authority's revenues.

Another aspect of the present invention may be to provide a method and apparatus that may enable a particular lottery authority to sell tickets to various lottery games through a variety of lottery player interactive devices, such as a lottery web site device, a point of sale device, a wireless device, or a television device, for example. In addition, such devices may be located in a wide variety of locations other than retail outlets, such as in the player's home or on the street, for example. These aspects of the present invention may be desirable because, for example, they make it much more convenient for a player to obtain information about lottery games being offered, and to purchase lottery tickets, thereby increasing player interest and the lottery revenues for that particular lottery authority.

A further aspect of the present invention may be to provide a method and apparatus that may enable a particular lottery authority to offer to its players a variety of new lottery-related features, such as an auto-purchase feature, an auto-deposit of winnings feature, an auto-notification feature, a lottery pool feature, a customized gift pack feature and a prize money beneficiary designation feature, for example. These aspects of the present invention may be desirable because, for example, they offer lottery players a rich assortment of desirable lottery-related conveniences and features, thereby making the lottery more attractive to potential players, and thus increasing the lottery revenues for that particular lottery authority. The lottery pool feature may be especially desirable because it may provide funding for individual causes, reputable charities and non-profit organizations of the player's choosing, rather than of the lottery authority's choosing.

Another aspect of the present invention may be to provide a lottery method and apparatus that comprises at least one suitably programmed and constructed lottery computer apparatus that may comprise a lottery authority administrative control system (AACS), a database, a server, a master game matrix (MGM), a lottery player interactive device; and a data communications link means for permitting data communications between said LAACS, said data base, said server, said MGM, and said lottery player interactive device. The data communications link means may also be for permitting data communications between the respective lottery apparatus of the participating lottery authorities; and for permitting data communications between the lottery apparatus of a participating lottery authority and the computer apparatus of third parties, such as a cell phone company or a cable television company.

It should be understood that the foregoing brief summary of the present invention does not set forth all of its objects, features, advantages, characteristics, structures, apparatus, materials, methods and processes, since these and further objects, features, advantages, characteristics, structures, apparatus, materials, methods and processes will be expressly or inherently disclosed to those of ordinary skill in the art to which it pertains in view of all of the disclosures herein.

### BRIEF DESCRIPTION OF THE DRAWING

FIG. 1 is a diagrammatic representation of one embodiment of the lottery method and apparatus of the present invention.

### DETAILED DESCRIPTION OF THE INVENTION

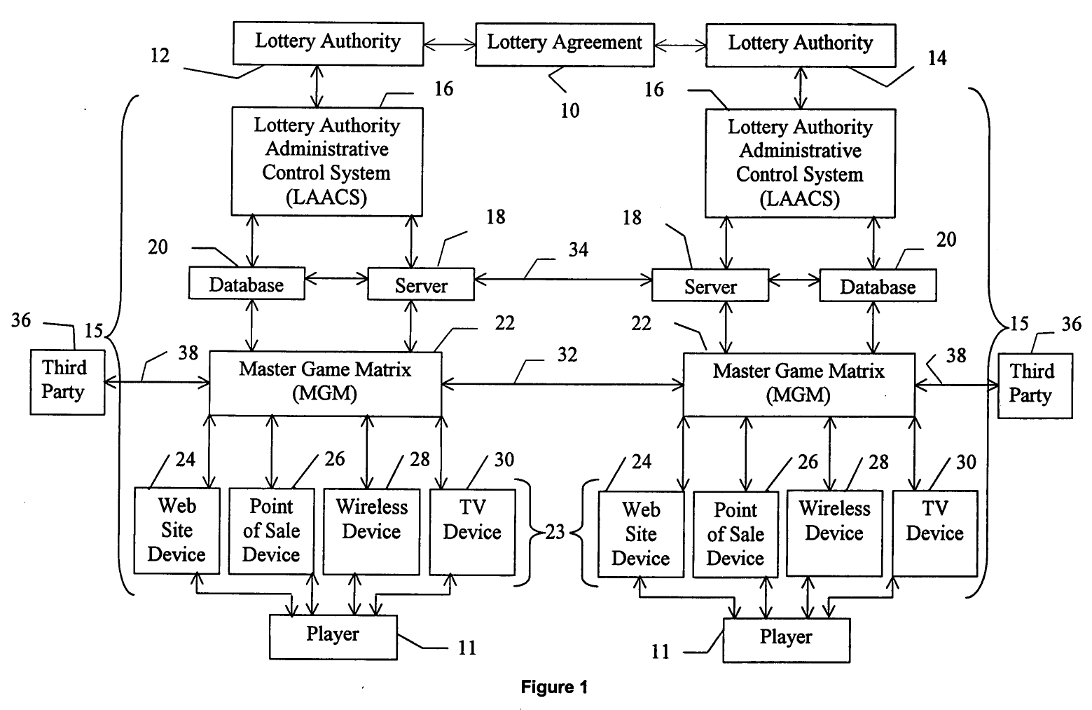

Turning now to FIG. 1, the present invention may comprise a first lottery authority 12 by itself; or it may comprise a first lottery authority 12 and a second lottery authority 14 entering into a lottery agreement 10.

Although two lottery authorities 12, 14 are illustrated, the invention may comprise more than two lottery authorities 12, 14. Any particular lottery authority may enter into a respective lottery agreement 10 with one, more than one, or all of the other lottery authorities.

Alternatively, there may be only a first lottery authority 12, in which case there would be no lottery agreement 10.

For simplicity, only the first and second lottery authorities 12, 14 will be addressed below. However, when a particular feature of the present invention is discussed with respect to either, or both, of the lottery authorities 12 or 14, it is understood that that particular feature may be equally applicable to every other lottery authority that may comprise part of the invention, unless the context should clearly indicate otherwise.

A particular lottery authority 12, 14 may be located in the U.S. or in any foreign country; and may comprise any governmental or non-governmental individual or entity authorized under the applicable local, state, federal or foreign laws and regulations to lawfully offer a public or private lottery.

Although only one lottery agreement 10 is illustrated between the two lottery authorities 12, 14, there may be more than one lottery agreement 10 between any particular two lottery authorities; and more than two lottery authorities may enter into any particular lottery agreement 10.

Each respective lottery agreement 10 may comprise at least some of the terms and conditions under which each participating lottery authority 12, 14 that is a party to the respective lottery agreement 10 may offer to lawfully sell lottery tickets to none, one, more than one, or all, of the lottery games that are originated by another participating lottery authority 12, 14. Any particular originated lottery game may comprise a set of lottery tickets. Such a set of lottery tickets may comprise, for example, all or less than all, of the lottery tickets sold for that particular originated lottery game prior to the drawing of each winning lottery ticket number for that particular originated lottery game.

An originating lottery authority 12, 14 may be said to have originated a particular lottery game, for example: when it owns that particular lottery game; when that particular lottery game is owned by a third party, but that originating lottery authority 12, 14 has acquired rights to that particular lottery game, such as under a license agreement or other contract with that third party; or when that originating lottery authority (or a third party from whom it has acquired rights to that particular lottery game), has the right to exclude other persons or entities from offering that particular lottery game, or lottery tickets to that particular lottery game, to third parties, such as to public or private persons or entities who may desire to purchase lottery tickets to that particular lottery game.

A lottery authority 12, 14 may participate in a respective lottery agreement 10 even though it has not originated any lottery games of its own, so that it may still offer to sell lottery tickets to any lottery game of its choosing that has been originated by any of the other participating lottery authorities 12, 14 with which it has entered into a respective agreement 10.

Each respective lottery agreement 10 may also comprise such other terms and conditions as the participating lottery authorities may feel are needed to effectuate it. For example, such other terms and conditions may relate to one or more of the following: lottery ticket prices and sales channels; lottery transaction payment methods and commissions; collection of sales and income taxes; allocation of proceeds; issuance and escrow of tickets; the collection and disbursement of prize money; the rules for how players 11 can pay for tickets and claim winning tickets; whether the players 11 are issued an actual ticket or a ticket receipt; how players 11 are authenticated; how players 11 are verified as being lawful players that are legally qualified to purchase a lottery ticket from lottery authority 12, 14, how players 11 can collect their winnings, and how proceeds are split between the lottery authorities, players 11, retailers, and all other applicable parties.

A lottery ticket receipt may be in any suitable form, including electronic form, and may contain information sufficient to enable the player to either redeem it for an actual ticket, or to claim a prize won by the ticket that is symbolized by the receipt.

Herein it is assumed that a player 11 is a lawful player 11, in that the player 11 has satisfied all applicable requirements to lawfully purchase a lottery ticket to a particular lottery from a particular lottery authority 12, 14; such as being of the requisite age, and being physically located in a requisite geographical area when purchasing a ticket, for example. One of the functions of the suitably programmed and constructed lottery computer apparatus 15 (described below), of a particular lottery authority 12, 14 may be to not sell the player 11 a lottery ticket, either directly or indirectly, unless the apparatus 15 has first verified, in any suitable way acceptable to that particular lottery authority 12, 14, that the player 11 satisfies all applicable requirements to lawfully purchase that lottery ticket.

Referring again to FIG. 1, the present invention may further comprise, for at least one of the lottery authorities 12, 14, a suitably programmed and constructed computer apparatus 15 that may comprise at least one of a lottery authority administrative control system, LAACS 16; a server 18; a data base 20; a master game matrix, MGM 22; and a lottery player interactive device 23 such as, for example, a lottery web site device 24; a lottery point of sale device 26, a lottery wireless device 28, a lottery television device 30, or any other suitable lottery player interactive device that enables a player to obtain information regarding lotteries, and to purchase lottery tickets.

Alternatively, there may be more than one of any or all of the components 16, 18, 20, 22, 23, 24, 26, 28, 30 of a particular computer apparatus 15, and there may be more than one computer apparatus 15 for a particular lottery authority 12, 14.

The computer apparatus 15, and each of its components 16, 18, 20, 22, 23, 24, 26, 28, 30, may each comprise one, or more, suitably programmed and constructed computers. Alternatively, any two, or more, of the components 16, 18, 20, 22, 23, 24, 26, 28, 30 may reside in whole, or in part, on a respective suitably programmed and constructed computer.

As another alternative, one or more of the functions of any particular one of the components 16, 18, 20, 22, 23, 24, 26, 28, 30 of a particular computer apparatus 15 may be performed by one or more of the other components 16, 18, 20, 22, 23, 24, 26, 28, 30 of that particular computer apparatus 15, or by one or more of the components 16, 18, 20, 22, 23, 24, 26, 28, 30 of any other computer apparatus 15. For example, although only one data base 20 is illustrated in FIG. 1, one or more of the other components 16, 18, 22, 23, 24, 26, 28, 30 may comprise a data base that serves one or more of the functions of the data base 20, and which may, or may not, replace the data base 20 in whole or in part. For example, multiple databases 20 may be provided when system replication is desired, when there are infrequent updates, or when automatic fail over to a local database is needed if a remote database is not available.

As another alternative, two or more of the lottery authorities 12, 14 may share in whole, or in part, a particular computer apparatus 15, or any or all of the components 16, 18, 20, 22, 23, 24, 26, 28, 30 of that particular computer apparatus 15. The respective computer apparatus 15 of any two lottery authorities 12, 14, may differ from each other in whole or in part.

The various arrows in FIG. 1 that extend between the various components 16, 18, 20, 22, 23, 24, 26, 28, 30 of a particular computer apparatus 15; that extend between the two computer apparatus 15 seen in FIG. 1; and that extend between each respective computer apparatus 15 and a player 11, a lottery authority 12 or a third party 36, indicate respective data communication links and show how data communications may flow between the respective boxes linked by their respective arrows.

For clarity, most of such arrows in FIG. 1 have not been given a reference numeral. Although double-headed arrows are illustrated, indicated bidirectional flow of data communications, such flow of data communications may be in only one direction between a respective pair of boxes. The arrows in FIG. 1 are by way of non-limiting example only, since there are many other possible alternative routes for the flow of data communications between any two or more boxes, which would still permit each computer apparatus 15, and each of its respective components 16, 18, 20, 22, 23, 24, 26, 28, 30 to fulfill at least some of their respective functions. For example, communications to and from a particular database 20 may flow directly to and from a particular third party 36 without going through a MGM 22.

A particular computer apparatus 15, and any of its components 16, 18, 20, 22, 23, 24, 26, 28, and 30, may further comprise at least one of: a data input apparatus, a data output apparatus, a communications apparatus, and a display apparatus that are selected, programmed, constructed, and arranged as needed to effectuate the functions of the present invention. Alternatively, there may be more than one of any, or all, of the data input apparatus, the data output apparatus, the communications apparatus, and the display apparatus.

It is understood that, as needed for the computer apparatus 15 of a particular lottery authority 12, 14 to perform its desired functions, during operation data may be exchanged between its various components 16, 18, 20, 22, 23, 24, 26, 28, 30 from time to time, and the data base 20 may be updated from time to time. Similarly, data may be exchanged between the respective computer apparatus 15 of different lottery authorities 12, 14, and their respective databases 20 may be updated from time to time. Similarly, data may be exchanged between a respective computer apparatus 15 and a player 11, a lottery authority 12, 14 or a third party 36; and the database 20 of the respective computer apparatus 15 may be updated from time to time.

Referring again to FIG. 1, the functions of the LAACS 16 may comprise enabling a particular lottery authority 12, 14 to control whether the LAACS 16 may be accessed and run locally or remotely; and to control the level of access and control that is permitted for any particular person, entity or apparatus that is duly authorized to do so by that particular lottery authority 12, 14.

Other functions of the LAACS 16 may comprise controlling and administering at least one of: the input, storage, retrieval, output, distribution, and display of at least one of the game information data, the player 11 information data, and the retailer information data between at least two of the components 16, 18, 20, 22, 23, 24, 26, 28, and 30 of the computer apparatus 15 of a particular lottery authority 12, 14; between the respective computer apparatus 15 of the lottery authorities 12, 14; or between a respective computer apparatus 15 and a player 11, a lottery authority 12, 14 or the computer apparatus of various third parties 36.

Such computer apparatus of third parties 36 may comprise, for example, the respective computer apparatus of a web host for a lottery web site device 24, of an operator for a point of sale device 26, of a communications company for a wireless device 28, or of a cable company for a television device 30.

Further functions of the LAACS 16 may comprise controlling and administering the communications and the exchange of data between the computer apparatus 15 of a particular lottery authority 12, 14 and a player 11, its particular lottery authority 12, 14, or the computer apparatus of such third parties 36. Such communications and exchange of data may be made, for example, by using any suitable voice or data connections, and by using any suitable communications and data protocols such as, for example, the industry standard Transmission Control Protocol (TCP), Internet Protocol (IP), HyperText Transfer Protocol (HTTP), Secured Sockets Layer (SSL), and Wireless Application Protocol (WAP).

For example, the functions of the LAACS 16 of a particular lottery authority 12, 14 may comprise controlling and administering the sending and receiving of game information data to and from each other participating lottery authority 12, 14 that is a party to a particular lottery agreement 10; to enable each participating lottery authority 12, 14 to sell the lottery games of its choosing from each other participating lottery authority 12, 14. By way of example, this is illustrated in FIG. 1 by the double-headed arrow 32 that extends between the two boxes labeled MGM 22. By way of another example, the functions of the LAACS 16 of a particular lottery authority 12, 14 may comprise controlling and administering the sending and receiving of game information data between its MGM 22 and a third party 36, as indicated by the double-headed arrows 38.

By way of further example, the functions of the LAACS 16 of a particular lottery authority 12, 14 may comprise controlling and administering the sending and receiving of any desired report data to and from each other participating lottery authority 12, 14 that is a party to a particular lottery agreement 10. Such report data may comprise any information that the respective participating lottery authorities 12, 14 may desire to send to or receive from each other such as, for example, payment information data, and data regarding players 11, ticket orders, and winners. By way of example, this exchange of report data is illustrated in FIG. 1 by the double-headed arrow 34 that extends between the two boxes labeled server 18.

Additional functions of the LAACS 16 may comprise at least one of: viewing, adding, modifying, deleting and displaying data relating to at least one of the game information data, player 11 information data, and retailer information data which may be stored in whole or in part on the data base 20 of the computer apparatus 15 of a particular lottery authority 12, 14. For example, a particular lottery authority 12, 14 may use the LAACS 16 to control what, if any, game information data may be received or displayed by a particular lottery player interactive device 23, what lottery players 11 may use a particular lottery player interactive device 23, and what retailers may offer any particular lottery player interactive device 23. A retailer may be any person, entity or device duly authorized by a particular lottery authority 12, 14 to sell game tickets to a player 11, whether directly or indirectly. Additional functions of the LAACS 16 may be to collect data on, monitor the operation of, and report on the operation of its respective computer apparatus 15, such as collecting data on usage statistics, monitoring the background processes, and reporting on the condition of any of the other components 18, 20, 22, 23, 24, 26, 28, 30.

A further function of the LAACS 16 may be to create at least part of the master game matrix MGM 22 of the computer apparatus 15 of a particular lottery authority 12, 14.

The LAACS 16 of a particular lottery authority 12, 14 may further comprise any suitable interface needed to permit that particular lottery authority 12, 14 to access and control one or more of the above functions of the LAACS 16. Such suitable interfaces may comprise, for example, a keyboard, a mouse, a voice recognition device, a touch screen, or a graphical user interface (GUI). A particular lottery authority 12, 14 may also interact and manage functions of the LAACS 16 through non-human action, such as by using automated mechanisms such as programming scripts and bots.

For each lottery game that is offered by a particular lottery authority 12, 14, the types of game information data on the computer apparatus 15 of that particular lottery authority 12, 14 that may be accessed, controlled, viewed, added, modified, deleted and displayed by the LAACS 16 of that particular lottery authority 12, 14 may comprise, for example, at least one of: the name of each lottery authority 12, 14 offering the game; the game's name, logo and artwork; the size of each jackpot; the cost of each particular kind of game ticket; the number and kind of plays that are permitted for the game; information regarding the game; the game's rules, restrictions and how to play it; the dates during which game tickets may be offered for sale; each of the game's drawing dates and times; the odds of winning; the retail locations at which a lottery player interactive device 23 for playing the game may be found; the number of tickets sold; the anticipated jackpots and prizes for upcoming (not yet drawn) games; the number of lottery pools entered into upcoming games; the names of the winners, the winning numbers and the prizes paid out for previously drawn games; how and to whom the proceeds from the game are distributed; and all other game information data as determined by that particular lottery authority 12, 14, such as any other type of game information data that is described herein, for example. Alternatively, that particular lottery authority 12, 14 may choose to not have any game information data for a particular game on its computer apparatus 15.

For each player 11 of a lottery game that is offered by a particular lottery authority 12, 14, the types of player 11 information data on the computer apparatus 15 of that particular lottery authority 12, 14 that may be accessed, controlled, viewed, added, modified, deleted and displayed by the LAACS 16 of that particular lottery authority 12, 14 may comprise, for example, at least one of: the player 11's name; age; temporary and permanent addresses; home, work and mobile telephone numbers; e-mail address; favorite numbers; payment methods used to purchase game tickets; physical location at the time any particular game ticket is purchased; data related to what retailer and interactive device 23 sold each game ticket purchased by the player 11; and all other player 11 information as determined by that particular lottery authority 12, 14. Alternatively, that particular lottery authority 12, 14 may choose to not have any player 11 information data for a particular player 11 on its computer apparatus 15, such as if, for example, the player 11 pays cash for a game ticket at an authorized point of sale device 26, or if the player 11 wishes to remain anonymous.

For each retailer of a lottery game that is offered by a particular lottery authority 12, 14, the types of retailer information data on the computer apparatus 15 of that particular lottery authority 12, 14 that may be accessed, controlled, viewed, added, modified deleted and displayed by the LAACS 16 of that particular lottery authority 12, 14 may comprise, for example, at least one of: the retailer's name, principal business address, telephone number, e-mail address, web address, identification information for the retailer's owners and management personnel, and logos or artwork; similar information regarding each different retail location of a particular retailer; identification data for each player interactive device 23 available at each retail location; commission rates and payments for game ticket sales by game, device 23 and location; commission rates and payments for cashing prize tickets, selling winning tickets, and performing other functions; and all other retailer information data as determined by that particular lottery authority 12, 14. Alternatively, that particular lottery authority 12, 14 may choose not to have any retailer information data for a particular retailer on its computer apparatus 15.

Referring again to FIG. 1, and as mentioned above, although only one master game matrix, MGM 22, is illustrated for a particular lottery authority 12, 14, it is understood that there may be more than one MGM 22 for that particular lottery authority 12, 14, and that all, or part, of each MGM 22 and its respective functions may be distributed to any other part of the computer apparatus 15. For example, one or more of the different kinds of lottery player interactive devices 23 (e.g., the respective devices 24, 26, 28, 30) may each comprise a separate, or different, MGM 22 that may be tailored for that particular kind of device 23.

The functions of the master game matrix, MGM 22 of the computer apparatus 15 of a particular lottery authority 12, 14 may comprise permitting that particular lottery authority 12, 14 to control at least one of: what games that particular lottery authority 12, 14 desires to permit on its computer apparatus 15, what are the contents of the permitted games, and the loading and updating of the permitted games and the game information data for the permitted games.

Such loading and updating of the permitted games and game information data may be done in any suitable way that is permitted by the MGM 22, such as, for example, by performing those tasks manually, or automatically through electronic data feeds. By way of example, a particular lottery authority 12, 14 may electronically download a particular lottery game or game information data for that particular lottery game from a different lottery authority 12, 14; or it may manually load that particular lottery game and its game information data from a cd or any other suitable storage media that has been supplied to it by that different lottery authority 12, 14.

The MGM 22 may then periodically update the game information data displayed for that particular lottery game by the player interactive devices 23 in any way desired by a particular lottery authority 12, 14 from the game information data regarding that particular lottery game that has been accumulated by the database 20 from the lottery player interactive devices 23 or from other lottery authorities 12, 14. Such updated game information data may comprise, for example, how many tickets have been sold, the odds of winning, and the size of the jackpot. Such updates may be performed at any time interval selected by the lottery authority 12, 14 such as every hour, for example. When the game information data is so updated, it may trigger further events. For example, a jackpot going over a particular dollar amount may trigger automatic ticket purchases by players 11, or automatic notifications to players 11, in a manner that will be described in more detail below.

The functions of the master game matrix MGM 22 of a particular lottery authority 12, 14 may comprise obtaining player 11 information data sufficient to enable that lottery authority 12, 14 to verify to its satisfaction that the player 11 is old enough at the time of purchasing a ticket to be lawfully sold a ticket to a lottery game offered by that lottery authority 12, 14, and to verify to its satisfaction that the player 11's physical location at the time of purchasing a ticket is such that the player 11 may lawfully be sold a ticket to a lottery game offered by that lottery authority 12, 14. Such player 11 information data may be obtained directly from the player 11, or may be obtained indirectly from the player 11, in any suitable way, such as from a third party 36, such as an authorized retailer who has obtained that data from the player 11.

Such player 11 information data may then be stored in the data base 20 and compared with any pre-set age and physical location criteria set by that particular lottery authority 12, 14, (which may also be stored in the data base 20), to determine whether that player 11's age and physical location meet such preset-criteria.

A player 11's age or physical location at the time of purchasing a ticket may be verified in any suitable way such as, for example: by relying on the oath, affirmation or declaration of the player 11 or a third party having knowledge thereof; by an authorized retailer who may be physically present at the time the player 11 purchases a ticket; by using the player 11's driver's license, birth certificate, passport, social security number, or other governmental identification documents through human or electronic verification; or by using the player 11's address, telephone number, or credit card billing information through human or electronic verification. The player 11's physical location may also be verified by verifying the location of the device 23 being used by player 11 at the time of purchasing a ticket, as is more fully described below.

The physical location of the player 11, or of the lottery player interactive device 23 used by the player 11 at the time of ticket purchase may also be verified in any other suitable way, such as for example, by: using a satellite global positioning device associated with the player 11 or with the device 23; using an authorized retailer who may be physically present at the time the player 11 purchases a ticket from a particular device 23; or by identifying the location of the device 23 at the time it is used by the player 11 to purchase a ticket.

Locating the device 23 (and thus locating the player 11 who uses it to purchase a ticket), may be done in any suitable way such as, for example, maintaining in the data base 20 verified location data regarding the physical location of any particular device 23.

For devices 23 whose location may be relatively fixed, such as a web site device 24, a point of sale device 26, or a TV device 30, for example, obtaining the location data may be as easy as knowing the street address at which the device 24, 26, 30 is located. For a web site device 24, the location data may be obtained from the device 24's owner or operator, or by using geolocation software that is designed to pinpoint the real world location of a web site user; for a point of sale device 26 the location data may be obtained from the retailer who has positioned the device 26 in a particular retail location; and for a TV device 30, the location data may be obtained from the cable or satellite service company that owns or services the device 30.

For devices 23 whose locations may vary, such as a wireless device 28, the location data may be obtained from the wireless communications provider, such as a cell phone systems provider. In this regard, it is understood that a cell phone provider like Motorola, which sells the physical cell phones, is different from a systems provider like AT&T Wireless, which provides the wireless communications services. The systems provider, not the cell phone provider would supply the desired location data.

A player 11's physical location at time of purchasing a ticket from a particular lottery authority 12, 14 may, or may not, be important, depending on the particular laws and regulations that may be applicable to that player 11 at the time the ticket is purchased by that player 11.

However, if a player 11 must be present in a particular geographical location in order to lawfully buy the ticket from a particular lottery authority 12, 14, then the MGM 22 of that particular lottery authority 12, 14 may permit that player 11 to purchase a ticket only if the player 11 can verify to that particular lottery authority's satisfaction that the player 11 is physically present in that particular geographical location at the time of purchasing a ticket, even though the MGM 22, for the general information of a player 11, may display game information data for games that may be lawfully sold only to a player 11 who is physically present in a different geographical location.

For example, if the applicable laws, regulations or policies of a particular lottery authority 12, 14 mandate that the player 11 must be physically present in California in order to lawfully purchase a ticket to a lottery game offered by a California lottery authority 12, 14, then the MGM 22 of the California lottery authority 12, 14 will only sell a ticket to a player 11 who can verify to the satisfaction of the California lottery authority 12, 14 that the player 11 is physically present in California at the time of purchase, even though the MGM 22, for the general information of the player 11, may display game information data to games that may be lawfully sold only to a player 11 who is physically present outside of California.

Of course, the California lottery authority 12, 14 may offer to sell to a player 11, who is physically present in California, a ticket to the lottery games of every other lottery authority 12, 14 with which the California lottery authority 12, 14 has an applicable reciprocal agreement 10, even though those other lottery authorities 12, 14 may be located in another state or country.

For the convenience of a player 11, that player 11's age and physical location may be pre-verified, such as by a particular lottery authority 12, 14 or by an authorized retailer, for example, in any suitable way to the satisfaction of that particular lottery authority 12, 14, to enable that player 11 to simply log in with the MGM 22 via any lottery player interactive device 23, and to then be able to immediately purchase a ticket sold by that particular lottery authority 12, 14 or authorized retailer, for example. This pre-verification may, or may not, be part of the process of a player 11 setting up an account with that particular lottery authority 12, 14 or with an authorized retailer, for example.

However, should that player 11 then move to, or be temporarily present in, a geographical location within the jurisdiction of a different lottery authority 12, 14, then in a similar fashion that player 11 may have to prove his age and physical location to the satisfaction of that different lottery authority 12, 14 in any way deemed acceptable to it before being able to buy tickets sold by that different lottery authority 12, 14 or its authorized retailers.

Thus, one of the MGM 22's functions may be to act as the keeper of the age and physical location qualification rules for a player 11 for a lottery authority 12, 14, but not necessarily to act as the enforcer of such rules, aside from not permitting a player 11 to buy a lottery ticket who does not meet those rules. Player rules may or may not differ by the particular device 23 being used and the physical location of the player 11.

Further functions of the master game matrix, MGM 22, of the computer apparatus 15 of a particular lottery authority 12, 14 may comprise permitting that particular lottery authority 12, 14 to control, for a particular lottery player interactive device 23, at least one of: which lottery games are permitted for that particular device 23, what game information data for each permitted game will be displayed on that particular device 23, how that game information data may be displayed on that particular device 23, and whether that particular device 23 may be permitted direct or indirect access to the MGM 22. Game information data may be displayed on that particular device 23 in any suitable way as determined by that particular lottery authority 12, 14.

For example, a particular lottery web site device 24 and a particular point of sale device 26 may, or may not, be permitted to display or sell the same games, display the same game information for each permitted game, display that game information in the same way for each permitted game, or be permitted access to the MGM 22 in the same way.

As a further example, all of the player interactive devices 23 of the same type, may or may not, be permitted to display or sell the same games, display the same game information for each permitted game, display that game information in the same way for each permitted game, and be permitted access to the MGM 22 in the same way. For example, two different point of sale devices 26 may be permitted to display or sell different games, display different game information for each permitted game, display that game information in a different way, and be permitted access to the MGM 22 in a different way.

However, for customer convenience and ease of use, the lottery authority 12, 14 may prefer to maximize the amount of uniformity and consistency in what games are permitted to be displayed or sold, in what game information data is displayed for each permitted game, in how that game information data is displayed, and in how access to the MGM 22 is permitted, at least for any given type of lottery player interactive device 23. For example, the lottery authority 12, 14 may choose to have all of its authorized point of sale devices 26 subject to such uniformity and consistency. The lottery authority 12, 14, may also choose to maximize such uniformity and consistency for different kinds of devices 23 (e.g., for the respective devices 24, 26, 28, 30), to the extent permitted by the respective capabilities or functionalities of such devices 24, 26, 28, 30.

The functions of a lottery player interactive device 23 may comprise, for example, enabling a player 11 to select a particular lottery game and to select the desired numbers for a ticket to that particular game. The device 23 may permit the player to select the desired numbers in any suitable way, such as by manually selecting the numbers in any suitable way, or by having the device 23 automatically generate the numbers for the ticket in any suitable way, such as by use of a random number generator or by using any other suitable number generating apparatus or method. It is a novel feature of the present invention to permit a player 11 to view randomly generated numbers on a device 23 prior to playing them, and to re-generate or modify them before committing to play them—something that a player 11 cannot do with conventional lottery systems.

It is understood that the term “numbers” regarding a lottery ticket is used in its broadest sense, and is defined to include not only Arabic numerals, but may also include one or more alphabet letters, roman numerals, symbols, or any other type of indicia that are selected by the player 11 or the device 23 for a lottery ticket for a particular lottery game. A legal set of “numbers” for a particular lottery game are particular to that game and may or may not be modifiable through the LAACS 16.

A player 11 may purchase a ticket for a game that is offered through a lottery player interactive device 23 for a particular lottery authority 12, 14 in any suitable way, such as by purchasing it explicitly or implicitly. Purchasing a ticket explicitly may comprise the player 11 directly initiating the purchase request, such as by clicking a “Buy Now” or other purchasing button on the display of the device 23. An implicit purchase may be one that is automatically initiated by the computer apparatus 15 in response to the player 11's pre-set purchasing criteria, which may reside on the database 20 of that particular lottery authority 12, 14 as part of an auto-purchase authorized by the player 11. The auto-purchase feature of the present invention will be described below in more detail.

Payment for the ticket may be made in any way that is authorized by the lottery authority 12, 14 that sold the ticket, such as cash, check, debit or credit card, or by charging it to a player 11's account that has been set up for the player 11. The player 11's account may be set up, for example, by or for the lottery authority 12, 14 that sold the ticket; or may be set up for the player 11 by or for any other person or entity that has been authorized to do so by the lottery authority 12, 14 that sold the ticket, such as by an authorized retailer, a cable company, a cell phone company, or a bank, for example.

Access to a player 11's account may be protected by any suitable security measures such as by use of a player 11's user identification and password, or by use of a smart card issued to a player 11 by a lottery authority 12, 14 or by any other authorized person or entity, to enable a player 11 to play lottery games through a device 23.

Such an account may also be used by the player 11 for receiving the proceeds from a winning ticket; and may receive deposits from the player 11 from time to time. Money in a player 11's account may be withdrawn by the player 11 from time to time, or used for future lottery ticket purchases, according to the terms and conditions agreed to between the player 11 and the authorized person or entity that set up the player 11's account.

After the player 11's purchase request has been initiated, it may be routed by the MGM 22 to the appropriate server 18 or database 20 of each lottery authority 12, 14 that either sold the ticket or originated the game. For example, if a player 11 in California purchased a ticket that was sold by a California lottery authority 12, but a New York lottery authority 14 originated the game, then the player 11's purchase request may be routed by the MGM 22 of the California lottery authority 12 to the servers 18 and databases 20 of both the California and New York lottery authorities 12, 14. On the other hand, if the California lottery authority both sold the ticket and originated the game, then the California lottery authority's MGM 22 may rout the player 11's purchase request to only the database 20 of the California lottery authority 12.

Depending on the type of player interactive device 23 that was used by the player 11, the player 11 may be issued, directly or indirectly, either an actual ticket or a ticket receipt, in any suitable way, such as in physical form or electronic form, for example.

After the originating lottery authority 12, 14 for a particular game officially draws the winning numbers for that particular game, the originating lottery authority 12, 14 may then upload the winning numbers to its database 20 and MGM 22, in any suitable way, such as by using its LAACS 16 or any suitable electronic automated mechanism, for example. Data regarding the winning numbers may then be distributed by the server 18 of the originating lottery authority 12, 14 to each of the other lottery authorities 12, 14 that are parties with it to a particular lottery agreement 10 regarding that particular game.

A player 11 may periodically check to see if he or she has a winning number, such as by using a lottery player interactive device 23. Alternatively, the winners may be notified in any suitable way by either the lottery authority 12, 14 from which they purchased the ticket, or by the originating lottery authority 12, 14 for that particular game. The MGM 22 may automatically do such notification, if the player 11 has enabled the auto-notification feature of the present invention, which will be described in more detail below.

A winning player 11 may then be paid the winnings in any way permitted by the originating lottery authority 12, 14. For example, a winning player may be paid by check or in cash, or the winnings may be credited to an account of the winning player 11.

A particular lottery authority 12, 14 may specify, via appropriate configuration settings in its LAACS 16, what amounts of winnings it may immediately pay to a player 11, and what amounts of winnings must be collected personally by the player 11. For example, in the case of a jackpot over a certain size, a particular lottery authority 12, 14 may demand that the winning player 11 appear in person for age verification, tax considerations, public relations opportunities, and the like.

Turning again to FIG. 1, the lottery player interactive devices 23 used by a particular lottery authority 12, 14 to display game information and sell tickets, will now be addressed. That particular lottery authority may, or may not, own any particular device 23, 24, 26, 28, 30. A particular device 23, or a particular kind of device 23 (such as the respective devices 24, 26, 28, 30), may have its own particular method or apparatus for communicating with the other components 16, 18, 20, 22 of the computer apparatus 15 of that particular lottery authority 12, 14, and may use any suitable apparatus or methods for maintaining the privacy or security of such communications, such as encryption, for example.

Any suitable apparatus or methods may be used to validate and restrict access to only authorized users regarding any of the lottery-related features available through a particular device 23, or through a particular kind of device 23 (such as the respective devices 24, 26, 28, 30), such as by the use of a user identification or password, for example. Such authorized users may comprise, for example, a particular lottery authority 12, 14; a retailer for a particular lottery; or a player 11 that may lawfully participate in a particular lottery by using the device 23.

As seen in FIG. 1, one kind of lottery player interactive device 23 may be a lottery web site device 24. The MGM 22 and the device 24 are the same as, or at least similar to, the MGM 22 and all of the other lottery player interactive devices 23 that are described herein (e.g., devices 26, 28, 30), in all respects, such as with respect to apparatus, software, functions, methods, processes, operations, features, advantages, characteristics and variations, except for those differences which will be made apparent to a person of ordinary skill in the art by all of the disclosures herein.

As also seen in FIG. 1, communications and data exchange between a third party 36 and the MGM 22 (or any other component of the computer apparatus 15 of a particular lottery authority 12, 14) may occur, and are indicated by the double-headed arrow 38. Such third parties may comprise, for example, at least one of: another lottery authority 12, 14, an authorized retailer, a wireless communications company, a cable or satellite TV company, a debit or credit card company, a bank or lending institution, a governmental organization, or a taxing authority, for example.

As has been mentioned, the MGM 22 may control at least one of: which lottery games are permitted to be displayed or sold for that particular device 24, what game information data for each permitted game will be displayed on that particular device 24, how that game information data may be displayed on that particular device 24, and how that particular device 24 may be permitted access to the MGM 22.

As was also mentioned earlier, the MGM 22 may, or may not, permit all of the lottery web site devices 24 to display or sell the same permitted games, display the same game information for each permitted game, display that game information in the same way for each permitted game, and be permitted access to the MGM 22 in the same way.

The lottery web site device 24 may comprise any public or private suitably programmed and constructed computer apparatus that may be utilized by an authorized user, such as by a player 11, to use the internet, in whole or in part, to exchange data with the MGM 22 of a computer apparatus 15 of a particular lottery authority 12, 14. Alternatively, the device 24 may directly access and exchange data with the MGM 22 in any other suitable way that does not use the Internet, in whole or in part, such as by using a direct telephone line, cable line, or wireless communications channel, for example.

The device 24 may comprise a portable computer; and may utilize wireless communications to connect the device 24 to the Internet, or directly to the MGM 22 without using the Internet, such as by using any suitable network or protocol, for example. The device 24 may comprise a printer for printing out, for example, a lottery ticket, a ticket receipt, or any other lottery-related information. The device 24 may comprise any suitable means for enabling the user to input data to the rest of the device 24, such as, for example: a keyboard, a mouse, a voice recognition device, a touch screen, or a graphical user interface (GUI).

A particular lottery authority 12, 14 may utilize a lottery web site operated by, or for, that particular lottery authority 12, 14 to perform the function of helping to enable a particular device 24 to exchange data with the MGM 22.

Alternatively, that particular lottery authority 12, 14 may utilize a hosted lottery web site to perform at least some of this function. Such a hosted lottery web site may be operated by, or for, a particular host, who may comprise, for example, a retailer, a wireless communications company, a cable or satellite TV company, or any other suitable person or entity that has been authorized by that particular lottery authority 12, 14 to operate a hosted lottery web site.

Hereinafter, for simplicity, all such hosts will be referred to as retailers.

Such a hosted web site may be co-branded, meaning that the MGM 22 will permit, for example, a particular retailer to conform its hosted lottery web site to at least some of the look and feel of that retailer's non-lottery web site, such as by adding that retailer's logo or other information regarding that retailer to that retailer's hosted lottery web site. A particular device 24 may navigate directly to a hosted lottery web site, or may navigate there indirectly through any suitable links, such as, for example, a link from a web site of that particular lottery authority 12, 14, or a link from that retailer's non-lottery web site.

The MGM 22 of a particular lottery authority may, or may not, permit that particular retailer to control at least one of: which lottery games are permitted to be displayed or sold on that retailer's hosted web site, what game information data for each permitted game will be displayed on that retailer's hosed web site, how that game information data may be displayed on that retailer's hosted web site, and how that retailer's hosted web site may be permitted access to the MGM 22. The MGM 22 may, or may not, permit that retailer to acquire web pages or other data from the MGM 22 and to then display those web pages or other data on the retailer's hosted lottery web site.

Payment for a ticket purchased by a player 11 from that retailer's hosted web site may be made in any suitable way. For example, the player 11 may pay that retailer in cash, or by check, debit or credit card, or by charging an account of the player 11. That retailer may then be responsible for forwarding payment for the ticket to the particular lottery authority 12, 14 that originated the game. Alternatively, the player 11 may directly pay that particular lottery authority 12, 14, in any suitable way, such as by debit or credit card, or by charging it to an account of the player 11, for example.

The functions of the MGM 22 of a particular lottery authority 12, 14 may comprise gathering data (which may then be stored on the database 20), regarding one or more of the following for a player 11 that has utilized a hosted web site to purchase a ticket: identification of that player 11; identification of each hosted web site that has set up an account for that player 11; identification of each hosted web site that has sold a ticket to a player 11; and information relating to that sold ticket, such as game and price paid, for example.

The functions of the MGM 22 of a particular lottery authority 12, 14 may comprise tracking and controlling at least some of the applicable financial data of that lottery authority 12, 14 relating to ticket sales, such as, for example: payments received from that lottery authority 12, 14 from a player 11 or a retailer; payments made by that particular lottery authority 12, 14 to a player 11 who purchased a winning ticket; and payments, such as commissions or credits, for example, made by that particular lottery authority 12, 14 to a retailer or to another lottery authority 12, 14.

Payments made by that particular lottery authority 12, 14 to a retailer may be based on such factors as whether that retailer set up an account for a player 11, or whether that retailer sold a ticket to that player 11, for example. Such commissions or credits may be determined between that particular lottery authority 12, 14 and that retailer in any suitable way, such as by a retail license agreement between them.

Because of the richness of the information from the MGM 22 that may be displayed on a lottery web site device 24 (or on any other lottery player interactive device 23, such as the devices 26, 28, 30, for example), a particular computer apparatus 15 of a particular lottery 12, 14 may offer its players 11 one or more of at least six ingenious and beneficial features, e.g., an auto-purchase feature, an auto-deposit of winnings feature, an auto-notification feature, a lottery pool feature, a customized gift pack feature and a prize money beneficiary designation feature, for example.

For simplicity, those six features will be discussed with respect to the lottery web site device 24, it being understood that one or more of those six features may be equally applicable to any other kind of lottery player interactive device 23, such as the devices 26, 28, 30, for example.

A player 11 may use a web site device 24 to select, de-select or enter information regarding any of those six features in any suitable way, such as, for example, by: clicking on or off a respective button or other indicia for a particular feature which may be displayed as part of the game information data from the MGM 22 that is displayed on the web site device 24; or entering information regarding that particular feature in any other suitable way, such as, for example, by use of: a keyboard, a mouse, a voice recognition device, a touch screen or a graphical user interface (GUI). For that particular feature, the MGM 22 may then periodically update the database 20, as needed, regarding the data entered by a player regarding that feature, and regarding any actions that the MGM 22 may have taken regarding that particular feature.

Each of those six features will now be addressed below in more detail.

Regarding the auto-purchase feature of the MGM 22, part of the game information data from the MGM 22 that may be displayed on the web site device 24 may enable a player 11 to select, de-select or enter information regarding one or more of any number of pre-set ticket buying criteria for purchasing a lottery ticket to a particular lottery game, a lottery ticket for a lottery pool, or a lottery ticket for a customized gift pack, for example. Such pre-set buying criteria may then be stored in the database 20 and then periodically compared by the MGM 22 to the game information data stored in the MGM 22.

The MGM 22 may then automatically purchase a ticket for that player 11 when the pre-set ticket buying criteria are met; and may then automatically charge the cost of that ticket to that player 11, such as by charging the cost to that player 11's credit or debit card, or to an account that player 11 may have previously set up with the selling lottery authority 12, 14, with an authorized retailer, or with a bank or lending institution, for example.

For each game or pool that a player 11 may desire to play, such pre-set ticket buying criteria may comprise, for example, at least one of: the name of the game or pool; the name and physical jurisdiction of the lottery authority 12, 14 originating the game or pool; the size of the jackpot; the odds of winning; the drawing date; the number of tickets sold to the game or pool; the name of each charitable or other kind of organization that may benefit from the sales of tickets; the ticket price; how many tickets to purchase; whether the player 11 desires the MGM 22 to randomly generate the numbers for each lottery ticket purchased, or to use numbers that have been previously selected by the player 11; how many plays per ticket to purchase (e.g., 1 play for $1.00, or 3 plays for $3.00); a dollar limit (e.g., no more that a certain value of tickets to be purchased over a particular time period or for a particular game); a date range (e.g., all games that meet the pre-set criteria between September and November); and any other pre-set buying criteria desired by that player 11.

Regarding the auto-deposit of winnings feature of the MGM 22, part of the game information data from the MGM 22 that may be displayed on the web site device 24 may enable a player 11 to select, de-select or enter information regarding one or more of such matters as: whether or not that player 11 desires to have the MGM 22 automatically collect and deposit all, or part, of the player 11's winnings from a particular winning ticket or pool to, for example, the player 11's credit or debit card, or to an account that the player 11 may have previously set up with the selling lottery authority 12, 14, with an authorized retailer, or with a bank or lending institution; and information needed to enable the MGM 22 to make such a deposit, such as information regarding the player 11's credit card, debit card, or account, for example.

The conditions under which auto-deposits of winnings may or may not occur may be specified by a particular lottery authority 12, 14 by using its LAACS 16. For example, that particular lottery authority 12, 14 may specify that only winnings of more, or less, than a pre-determined dollar amount may be auto-deposited.

Regarding the auto-notification feature of the MGM 22, part of the game information data from the MGM 22 that may be displayed on a web site device 24 may enable a player 11 to select, de-select or enter information regarding whether or not that player 11 desires to have the MGM 22 automatically notify that player 11 of the occurrence, or non-occurrence, of a designated event, and whether the event requires that player 11's confirmation, or should automatically take place.

Such designated events may comprise any event of interest to the player 11 regarding which the lottery authority 12, 14 has enabled its MGM 22 to accept input from the player 11 and to send output to the player 11. For example, such designated events may comprise at least one of: a lottery game or lottery pool meeting a player 11 's pre-set buying criteria, so that the player 11 may choose to purchase a ticket if the player has not selected the auto-purchase feature for that game or pool; a purchase of a ticket for that player 11 by the MGM 22 under the auto-purchase feature of the present invention; the winning or loss of a particular game or pool by that player 11; the amount of the wins or losses; the deposit by the MGM 22 of that player 11's winnings under the auto-deposit of winnings feature of the present invention; and any lottery pools, customized gift packs and prize money beneficiary designations entered into or made by that player 11, for example. Regarding any particular designated event, the notification sent by MGM 22 may further comprise relevant information relating to that event. The auto-notification feature may notify the player 11 of the occurrence, or non-occurrence, of a designated event in any suitable way, such as, for example, by mail, e-mail, SMS text messaging, pager, or automated message by phone.

Regarding the lottery pool feature of the MGM 22, it may comprise an open lottery pool creation feature; a closed lottery pool creation feature; a lottery pool entry feature; and a lottery pool third party proceeds designation feature regarding what a particular designated third party person or entity will be paid regarding a particular ticket surcharge or a particular jackpot by that lottery authority 12, 14.

More particularly, part of the game information data from the MGM 22 that may be displayed on a web site device 24 may enable a player 11 to select, de-select or enter information regarding one or more of such matters as: whether or not that player 11 desires to have the MGM 22 create a lottery pool for that player 11 (which may then be entered by that player 11 after having been created); or to enter that player 11 into an existing lottery pool that may have already been created by another player 11 or entity, or by a particular lottery authority 12, 14.

Any particular lottery pool may be formed for at least one game and for at least one drawing for which a particular lottery authority 12, 14 sells tickets, and may include games from more than one lottery authority 12, 14, so long as the respective lottery authorities 12, 14 permit it via their respective lottery agreement 10.

For a created or an existing lottery pool, part of the game information data from the MGM 22 that may be displayed on a web site device 24 may enable a player 11 to select, de-select or enter information regarding one or more of such matters as: whether or not that player wants to join that pool; the number of tickets to be purchased; the desired ticket numbers; the name of the pool's creator; the rules for that pool; the number of tickets sold in that pool to date; the odds of winning that pool; the designation of each third party person or entity (such as a charity, for example) to be paid a particular surcharge on each ticket sold in that pool; the amount of that particular surcharge; how that pool's jackpots are to be split among the participating players 11; the designation of each third party person or entity (such as a charity, for example) to whom a part of the pool's jackpots may be given; and the amount of the pool's jackpots that may be given to each designated third party person or entity, for example.

An entry into a pool may not be for a specific ticket, but for a fund that later purchases a pool of tickets. The rules for a particular pool may specify that the player 11 gets a “share” of any winning tickets in the pool, but only if the winnings are over a certain pre-determined dollar amount that is set forth in the rules. This is because it would not make sense, for example, for 2000 players 11 in a pool to split total winnings of $2.00. Any undistributed winnings under such a rule may be accumulated in the pool until the predetermined dollar amount has been reached; or the undistributed winnings may be applied in any other way specified by the rules, such as by being given to a specified charity, for example. A player 11's distributed pool winnings may be deposited into the player 11's account by use of the auto-deposit of winnings feature of the present invention that was discussed above.

Part of the game information data from the MGM 22 that may be displayed on a web site device 24 may enable a player 11 to create his or her own pool by selecting, de-selecting, or entering information regarding one or more of such matters as: whether to create an open pool (i.e., another player 11 may join the pool without an invitation or permission from the creating player 11), or a closed pool (i.e., another player 11 may not join the pool unless invited or given permission by the creating player 11); the rules for the pool; the designation of each third party person or entity (such as a charity, for example) to be paid a particular surcharge on each ticket sold in that pool; the amount of that particular surcharge; how the pool's jackpots are to be split among the participating players 11; the predetermined dollar amount of winnings needed before a distribution of winnings to the participating players 11 may be made; the designation of each third party person or entity (such as a charity, for example) to whom a part of the pool's jackpots may be given; and the amount of the pool's jackpots that may be given to each designated third party person or entity, for example.

The tickets for inclusion in any particular pool may be purchased directly from a lottery authority 12, 14 or from any other person or entity authorized by that lottery authority 12, 14 to sell the desired tickets. All duly entered players 11 in the pool may be notified by e-mail, or by any other suitable means, of such matters as, for example: the number of tickets purchased by the pool and the numbers for each ticket purchased. Such notifications may be made under the auto-notification feature of the present invention.

The ability for a player 11 to join an existing pool, or to create a new pool, wherein the pool may contribute a surcharge on each ticket sold, or a portion of one or more of the jackpots from the pool, to a particular designated third party person or entity (such as a charity, for example) that the player 11 desires to help is believed to be a novel feature of the present invention. This is because, under lotteries currently being offered, the players 11 cannot designate the third party person or entity that may share some of the proceeds of the lottery (whether surcharges or jackpots), or the amount that each designated third party person or entity may share. Instead, the lottery authority 12, 14 normally makes those designations and sets those amounts on a take-it-or-leave-it-basis to a player 11.

Thus, the present invention may provide a method and apparatus by which the players 11 may choose to support a wide variety of particular third party persons or entities that have been designated by the players 11, rather than by the lottery authority 12, 14. The present invention may also help to ensure that those persons or entities are paid, since the MGM 22 of a particular lottery authority 12, 14 may notify each designated person or entity of the amount to which it is entitled, and may send the appropriate surcharge on the pool ticket sales and the appropriate share of the pool jackpots directly to each designated person or entity. Such notifications may be made under the auto-notification feature of the present invention, and such surcharges or share of pool jackpots may be sent to the designated person or entity under the auto-deposit of winnings feature of the present invention.

The MGM 22 may control any or all aspects of any pool that it contains, from the pool's creation to the payment of pool ticket surcharges and pool jackpots to the appropriate players 11, persons or entities. Pertinent data relating to the pool may be stored in the database 20 and updated periodically by the MGM 22.

Regarding the customized gift pack feature of the present invention, in general the MGM 22 of a particular lottery authority 12, 14 may permit a lottery player 11 donor to purchase a selected lottery ticket, or more than one ticket from more than one lottery authority 12, 14 as a gift, and to customize the gift ticket for the recipient. The MGM 22 of the particular lottery authority 12, 14 that sold the ticket may notify the recipient of the gift, and deliver the gift ticket to the recipient, either in the form of a physical ticket, a ticket receipt, or in any other suitable form. The donor may be charged for the gift ticket, and the donor and recipient may be notified regarding them, in any suitable way.

Part of the game information data from the MGM 22 that may be displayed on the web site device 24 may enable a player 11 donor to create a customized gift pack comprising one or more gift tickets by selecting, de-selecting or entering information for each gift ticket regarding one or more of such matters as, for example: the game for which the gift ticket is desired; the cost of the gift ticket; the numbers for the gift ticket, the name of the donor and recipient of the gift ticket; the message on the gift ticket from the donor to the recipient; the recipient's name, address, and e-mail address; the delivery method for the gift ticket; the verification of the recipient's age and physical location; the donor's payment information; the issuance of a gift ticket or a gift ticket receipt to the recipient; the delivery of a gift ticket purchase confirmation to the donor; and the issuance of a delivery confirmation to the donor when the gift ticket has been delivered to the recipient. The MGM 22 may also display any other pertinent information, such as the rules that are applicable to the custom gift packs, for example.

Alternatively, part of the game information data from the MGM 22 that may be displayed on a web site device 24 may enable a donor to permit the recipient to select, de-select or enter information regarding one or more of such matters as, for example: each particular game that the recipient desires to play; and the recipient's desired numbers for each gift ticket to that particular game.

If the recipient is enabled to select each game and the numbers for each gift ticket, then the MGM 22 may notify the recipient of the gift tickets, and invite the recipient to use a web site device 24 to select, de-select, or enter information regarding one or more of such matters as, for example: verification of the recipient's eligibility to lawfully receive the gift tickets; the name of each particular game that the recipient desires to play; and the desired numbers for each gift ticket to that particular game. The MGM 22 may also display any other pertinent information for the recipient, such as, for example: any message from the donor relating to each gift ticket; and the rules that are applicable to the custom gift packs, for example.

Regarding the prize money beneficiary designation feature of the present invention, in general the MGM 22 of a particular lottery authority 12, 14 may permit a player 11 to designate a beneficiary to whom the player 11's prize money will be disbursed for any particular winning ticket or lottery pool, if a particular designated triggering event occurs. A triggering event may comprise, for example: the death of that player 11; the incapacitation of that player 11; or the failure of that player 11 to collect the prize money within a certain period of time following the drawing in which the numbers on the winning ticket were drawn. If a triggering event occurs, the MGM 22 may then disburse the prize money to the designated beneficiary, in accordance with the terms of the beneficiary designation. This feature ensures that lottery player 11's prize money will be properly collected and dispersed according to the player 11's wishes if any of the designated triggering events should occur. The beneficiary may comprise a person or an entity.

Part of the game information data from the MGM 22 that may be displayed on web site device 24 may enable a player 11 to create a prize money beneficiary designation by selecting, de-selecting or entering information regarding one or more of such matters as, for example: the name and address or other identifying information regarding the player 11 and the designated beneficiary; the terms and conditions under which prize money is to be disbursed to the designated beneficiary; and any related notifications to the player 11 and the designated beneficiary, for example. The MGM 22 may also display any other pertinent information, such as the rules that are applicable to the designation of a prize money beneficiary, for example.

Turning again to FIG. 1, the point of sale (POS) device 26 will now be addressed. The MGM 22 and the device 26 are the same as, or at least similar to, the MGM 22 and all of the other lottery player interactive devices 23 that are described herein (e.g., devices 24, 28, 30), in all respects, such as with respect to apparatus, software, functions, methods, processes, operations, features, advantages, characteristics and variations, except for those differences which will be made apparent to a person of ordinary skill in the art by all of the disclosures herein.

The POS device 26 may be in the form of a publicly available terminal or kiosk that has been placed in a location that has been authorized by a particular lottery authority 12, 14. The device 26 may be owned or operated by or for a particular lottery authority 12, 14, or may be owned or operated by or for a particular retailer. The display on the device 26 may be co-branded with the retailer in which the device 26 may be located, such as by displaying the retailer's logo, information regarding the retailer, or links to the retailer's web site, for example.

The device 26 may comprise an apparatus for performing at least one of the functions of: identifying and authenticating player 11 by any suitable means, such as by a use of a smart card, credit or debit card, unique user name and password log-in, or retina or fingerprint scan, for example; and accepting payment from a player 11 in any suitable way, such as in the form of cash, a smart card, credit or debit card, or an authorization to charge an account that the player 11 may have previously set up with the selling lottery authority 12, 14, with an authorized retailer, or with a bank or lending institution, for example.

The device 26 may also comprise an apparatus for dispensing prize money to the player 11, such as in the form of cash; a receipt that can be redeemed by presenting such to a retailer or lottery authority attendant in person or by mail; a check; a credit to a credit or debit card; or a credit to an account that the player 11 may have previously set up with the selling lottery authority 12, 14, with an authorized retailer, or with a bank or lending institution, for example.

The MGM 22 may be configured to permit the device 26 to perform at least some of its functions with or without requiring the aid of an authorized attendant. If the aid of an attendant is required, the attendant may perform such functions as, for example: verifying that a player 11 is legally qualified to purchase a lottery ticket, receiving payment from the player 11 for the ticket, issuing a ticket or a ticket receipt to the player 11, or dispensing prize money to the player 11. One of the functions of the MGM 22 may be to accept input from an authorized attendant that notifies the MGM 22 that the attendant has performed a particular function, and that sets forth any applicable details regarding that attendant-performed function that may be required by the MGM 22.

A lottery ticket or ticket receipt issued by the device 26 or by the authorized attendant may contain all appropriate information required by the MGM 22, such as, for example, at least one of: the date and time the ticket or ticket receipt was issued; the name of the applicable lottery game; the selected numbers; the drawing date; indicia that identify a particular device 26; indicia that identify the retailer and the retailer's location in which the device 26 is situated; indicia used for security and fraud-prevention such as watermarks or encryption; or any other appropriate information. This information may be stored in the database 20 and used by the MGM 22 in any suitable way, such as to credit retailers with a commission for the sold ticket, and to make notifications and payments to winning players 11 for individual tickets and pool entries

Turning again to FIG. 1, the wireless device 28 will now be addressed. The MGM 22 and the device 28 are the same as, or at least similar to, the MGM 22 and all of the other lottery player interactive devices 23 that are described herein (e.g., devices 24, 26, 30), in all respects, such as with respect to apparatus, software, functions, methods, processes, operations, features, advantages, characteristics and variations, except for those differences which will be made apparent to a person of ordinary skill in the art by all of the disclosures herein.

A wireless device 28 may comprise at least one device, the functions of which may comprise, for example, as least one of: enabling an MGM 22 of a particular lottery authority 12, 14 to display game related data on the device 28, or to output data through the device 28 to another device, such as to a player 11's printer for printing tickets or ticket receipts, for example; and enabling a player 11 to input lottery game related data to the MGM 22, either directly or indirectly.

The device 28 may comprise, for example, at least one of: a mobile or cell phone; a Personal Digital Assistant (PDA); a portable personal computer; or any other suitable wireless device.

Functions of the MGM 22 may comprise at least one of: displaying information on the player 11's device 28 regarding authorized lottery retailers for a particular lottery game, to enable a player 11 to go to an authorized lottery retailer if he or she desires, such as for purchasing a lottery ticket, or for redeeming a winning ticket, for example; crediting to an authorized retailer the sale of a ticket purchased by a player 11 with the device 28; and paying that authorized retailer a commission on that sale.

The person or entity that provides the device 28, or that provides the device 28 with communications capabilities, such as a mobile or cell phone voice and/or data services company, for example, may be considered to be an authorized retailer by the MGM 22. The functions of such an authorized retailer may include, for example, at least one of: receiving a commission on a lottery ticket bought by a player 11 through the device 28; paying the lottery authority 12, 14 for that lottery ticket; charging the cost of the ticket to the player 11's account, such as the player's account with that authorized retailer; applying the player 11's winnings to the player 11′ account; and providing the MGM 22 with data regarding the geographical location of a particular device 28, to enable the MGM 22 to verify the geographical location of the player 11 using that particular device 28, or to enable the MGM 22 to direct the player 11 to any other authorized retailer, such a retailer having store near to that particular device 28 where that player may engage in lottery-related activities.

Turning again to FIG. 1, the television device 30 will now be addressed. The MGM 22 and the device 30 are the same as, or at least similar to, the MGM 22 and all of the other lottery player interactive devices 23 that are described herein (e.g., devices 24, 26, 28), in all respects, such as with respect to apparatus, software, functions, methods, processes, operations, features, advantages, characteristics and variations, except for those differences which will be made apparent to a person of ordinary skill in the art by all of the disclosures herein.

A television (TV) device 30 may comprise at least one device, the functions of which may comprise, for example, as least one of: enabling an MGM 22 of a particular lottery authority 12, 14 to display game related data on a player 11's TV, or to output data through the device 30 to another device, such as to a player 11's printer for printing tickets or ticket receipts, for example; and enabling a player 11 to input lottery game related data to the MGM 22, either directly or indirectly.

The device 30 may comprise, for example, at least one of: the player 11's TV; any suitable cable, satellite or other television set-top box or other device for permitting communications between the MGM 22 and the player 11's TV; and any suitable input device for the player 11, such as a television remote control, a keyboard, a mouse, a voice recognition device, or a graphical user interface (GUI), for example, that may enable the player 11 to input data to the MGM 22.

Functions of the MGM 22 may comprise at least one of: displaying information on the player 11's TV regarding authorized lottery retailers for a particular lottery game, to enable a player 11 to go to an authorized lottery retailer if he or she desires, such as for purchasing a lottery ticket, or for redeeming a winning ticket, for example; crediting to an authorized retailer the sale of a ticket purchased by a player 11 with the device 30; and paying that authorized retailer a commission on that sale.

The person or entity that provides the device 30, or that provides the device 30 with communications capabilities, such as a cable or satellite TV company, for example, may be considered to be an authorized retailer by the MGM 22. The functions of such an authorized retailer may include, for example, at least one of: receiving a commission on a lottery ticket bought by a player 11 through the device 30; paying the lottery authority 12, 14 for that lottery ticket; charging the cost of the ticket to the player 11's account, such as the player's account with that authorized retailer; applying the player 11's winnings to the player 11′ account; and providing the MGM 22 with data regarding the geographical location of a particular device 30, to enable the MGM 22 to verify the geographical location of the player 11 using that particular device 30, or to enable the MGM 22 to direct the player 11 to any other authorized retailer, such a store near to that particular device 30.

As used herein, except in the claims, the words “and” and “or” are each defined to also carry the meaning of “and/or”.

It is understood that the foregoing forms of the invention were described and illustrated strictly by way of non-limiting example. Accordingly, these and further modifications, adaptations and variations of the present invention will now be apparent to those of ordinary skill in the art to which it pertains in view of all of the disclosures herein, within the scope of the following claims,

1. A lottery method for at least two participating lottery authorities, wherein said lottery method comprises the steps of:
a. at least one of said participating lottery authorities originating a respective originated lottery game comprising a set of lottery tickets;
b. all of said participating lottery authorities entering into a lottery agreement; and
c. all of said participating lottery authorities specifying in said lottery agreement that at least one of said participating lottery authorities is authorized to sell at least one of said lottery tickets of said respective originated lottery game of at least one other of said participating lottery authorities.

2. The method of claim 1, wherein said method further comprises the steps of:
d. each of said participating lottery authorities originating a respective originated lottery game; and
e. all of said participating lottery authorities specifying in said lottery agreement that each of said participating lottery authorities is authorized to sell at least one of said lottery tickets of said respective originated lottery game of each of the other of said participating lottery authorities.

3. The method of claim 1, wherein said method further comprises the step of:
d. at least one of said participating lottery authorities not originating a respective originated lottery game.

4. The method of claim 1, wherein said method further comprises the steps of at least one of said participating lottery authorities:
d. selecting a suitably programmed and constructed lottery computer apparatus;
e. selecting said lottery computer apparatus to comprise at least one lottery player interactive device; and
f. selecting said at least one lottery player interactive device to be operable for enabling a lottery player to purchase at least one of said lottery tickets for a respective originated lottery game of at least one of said participating lottery authorities.

5. The method of claim 4, wherein said method further comprises the steps of at least two of said participating lottery authorities:
g. selecting a respective said lottery computer apparatus; and
h. selecting each said respective lottery computer apparatus to comprise a data communications link means for permitting data communications between each said respective lottery computer apparatus.

6. The method of claim 4, where the method further comprises the step of at least one of said participating lottery authorities:
g. selecting a particular one of said at least one lottery player interactive device to comprise a lottery web site device.

7. The method of claim 4, where the method further comprises the step of at least one of said participating lottery authorities:
g. selecting a particular one of said at least one lottery player interactive device to comprise a lottery point of sale device.

8. The method of claim 4, where the method further comprises the step of at least one of said participating lottery authorities:
g. selecting a particular one of said at least one lottery player interactive device to comprise a lottery wireless device.

9. The method of claim 4, where the method further comprises the step of at least one of said participating lottery authorities:
g. selecting a particular one of said at least one lottery player interactive device to comprise a lottery television device.

10. The method of claim 4, wherein said method further comprises the step of at least one of said participating lottery authorities:
g. selecting a particular one of said at least one lottery player interactive device to be operable for enabling said lottery player to select an auto-purchase feature.

11. The method of claim 4, wherein said method further comprises the step of at least one of said participating lottery authorities:
g. selecting a particular one of said at least one lottery player interactive device to be operable for enabling said lottery player to select an auto-deposit of winnings feature.

12. The method of claim 4, wherein said method further comprises the step of at least one of said participating lottery authorities:
g. selecting a particular one of said at least one lottery player interactive device to be operable for enabling said lottery player to select an auto-notification feature.

13. The method of claim 4, wherein said method further comprises the step of at least one of said participating lottery authorities:
g. selecting a particular one of said at least one lottery player interactive device to be operable for enabling said lottery player to select a customized gift pack feature.

14. The method of claim 4, wherein said method further comprises the step of at least one of said participating lottery authorities:
g. selecting a particular one of said at least one lottery player interactive device to be operable for enabling said lottery player to select a prize money designation feature.

15. The method of claim 4, wherein said method further comprises the step of at least one of said participating lottery authorities:
g. selecting a particular one of said at least one lottery player interactive device to be operable for enabling said lottery player to select a lottery pool feature.

16. The method of claim 15, wherein said method further comprises the step of at least one of said participating lottery authorities:
h. selecting said lottery pool feature to be operable for enabling said lottery player to select an open lottery pool creation feature.

17. The method of claim 15, wherein said method further comprises the step of at least one of said participating lottery authorities:
h. selecting said lottery pool feature to be operable for enabling said lottery player to select a closed lottery pool creation feature.

18. The method of claim 15, wherein said method further comprises the step of at least one of said participating lottery authorities:
h. selecting said lottery pool feature to be operable for enabling said lottery player to select a lottery pool third party proceeds designation feature.

19. A suitably programmed and constructed lottery computer system for at least two participating lottery authorities, wherein at least one of said participating lottery authorities originates a respective originated lottery game comprising a set of lottery tickets; and wherein said system is operable to enable at least one of said participating lottery authorities to offer for sale at least one of said lottery tickets of said respective originated lottery game of at least one other of said participating lottery authorities.

20. The system of claim 19, wherein each of said participating lottery authorities originates a respective originated lottery game; and wherein said lottery computer system is operable to enable each of said participating lottery authorities to offer for sale at least one of said lottery tickets of said respective originated lottery game of each of the other of said participating lottery authorities.

21. The system of claim 19, wherein at least one of said participating lottery authorities has not originated a respective originated lottery game.

22. The system of claim 19, wherein said system comprises a respective suitably programmed and constructed lottery computer apparatus for at least one of said participating lottery authorities;
wherein each said respective lottery computer apparatus comprises a LAACS, a database, a server, a MGK a lottery player interactive device; and a data communications link means for permitting data communications between said LAACS, said data base, said server, said MGM, and said lottery player interactive device; and
wherein said lottery player interactive device is operable to enable a lottery player to purchase at least one of said lottery tickets for a respective originated lottery game of at least one of said participating lottery authorities.

23. The system of claim 22, wherein said system further comprises at least two of said respective said lottery computer apparatus, for at least two of said participating lottery authorities; and wherein said data communications link means are also for permitting data communications between each said respective lottery computer apparatus.

24. The system of claim 22, wherein said system further comprises at least one of said lottery player interactive device; and wherein a particular one of said least one lottery player interactive device comprises a lottery web site device.

25. The system of claim 22, wherein said system further comprises at least one of said lottery player interactive device; and wherein a particular one of said least one lottery player interactive device comprises a lottery point of sale device.

26. The system of claim 22, wherein said system further comprises at least one of said lottery player interactive device; and wherein a particular one of said least one lottery player interactive device comprises a lottery wireless device.

27. The system of claim 22, wherein said system further comprises at least one of said lottery player interactive device; and wherein a particular one of said least one lottery player interactive device comprises a lottery television device.

28. The system of claim 22, wherein said particular one of said at least one lottery player interactive device is operable to enable a lottery player to select an auto-purchase feature.

29. The system of claim 22, wherein said particular one of said at least one lottery player interactive device is operable to enable a lottery player to select an auto-deposit of winnings feature.

30. The system of claim 22, wherein said particular one of said at least one lottery player interactive device is operable to enable a lottery player to select an auto-notification feature.

31. The system of claim 22, wherein said particular one of said at least one lottery player interactive device is operable to enable a lottery player to select a customized gift pack feature.

32. The system of claim 22, wherein said particular one of said at least one lottery player interactive device is operable to enable a lottery player to select a prize money designation feature.

33. The system of claim 22, wherein said particular one of said at least one lottery player interactive device is operable to enable a lottery player to select a lottery pool feature.

34. The system of claim 33, wherein said lottery pool feature is operable to enable said lottery player to select an open lottery pool creation feature.

35. The system of claim 33, wherein said lottery pool feature is operable to enable said lottery player to select a closed lottery pool creation feature.

36. The system of claim 33, wherein said lottery pool feature is operable to enable said lottery player to select a lottery pool third party proceeds designation feature.

37. A lottery method for a lottery authority for offering a lottery game comprising a set of lottery tickets, wherein said lottery method comprises the steps of said lottery authority:
a. selecting a suitably programmed and constructed lottery computer apparatus;
b. selecting said lottery computer apparatus to comprise at least one lottery player interactive device; and
c. selecting said at least one lottery player interactive device to be operable for enabling a lottery player to purchase at least one of said lottery tickets.

38. The method of claim 37, where the method further comprises the step of said lottery authority:
d. selecting a particular one of said at least one lottery player interactive device to comprise a lottery web site device.

39. The method of claim 37, where the method further comprises the step of said lottery authority:
d. selecting a particular one of said at least one lottery player interactive device to comprise a lottery point of sale device.

40. The method of claim 37, where the method further comprises the step of said lottery authority:
d. selecting a particular one of said at least one lottery player interactive device to comprise a lottery wireless device.

41. The method of claim 37, where the method further comprises the step of said lottery authority:
d. selecting a particular one of said at least one lottery player interactive device to comprise a lottery television device.

42. The method of claim 37, wherein said method further comprises the step of said lottery authority:
d. selecting a particular one of said at least one lottery player interactive device to be operable for enabling said lottery player to select an auto-purchase feature.

43. The method of claim 37, wherein said method further comprises the step of said lottery authority:
d. selecting a particular one of said at least one lottery player interactive device to be operable for enabling said lottery player to select an auto-deposit of winnings feature.

44. The method of claim 37, wherein said method further comprises the step of said lottery authority:
d. selecting a particular one of said at least one lottery player interactive device to be operable for enabling said lottery player to select an auto-notification feature.

45. The method of claim 37, wherein said method further comprises the step of said lottery authority:
d. selecting a particular one of said at least one lottery player interactive device to be operable for enabling said lottery player to select a customized gift pack feature.

46. The method of claim 37, wherein said method further comprises the step of said lottery authority:
d. selecting a particular one of said at least one lottery player interactive device to be operable for enabling said lottery player to select a prize money designation feature.

47. The method of claim 37, wherein said method further comprises the step of said lottery authority:
d. selecting a particular one of said at least one lottery player interactive device to be operable for enabling said lottery player to select a lottery pool feature.

48. The method of claim 47, wherein said method further comprises the step of said lottery authority:
e. selecting said lottery pool feature to be operable to enable said lottery player to select an open lottery pool creation feature.

49. The method of claim 47, wherein said method further comprises the step of said lottery authority:
e. selecting said lottery pool feature to be operable for enabling said lottery player to select a closed lottery pool creation feature.

50. The method of claim 47, wherein said method further comprises the step of said lottery authority:
e. selecting said lottery pool feature to be operable for enabling said lottery player to select a lottery pool third party proceeds designation feature.

51. A suitably programmed and constructed lottery computer system for a lottery authority offering a lottery game comprising a set of lottery tickets,
wherein said system comprises a suitably programmed and constructed lottery computer apparatus;
wherein said lottery computer apparatus comprises a LAACS, a database, a server, a MGM, a lottery player interactive device; and a data communications link means for permitting data communications between said LAACS, said data base, said server, said MGK, and said lottery player interactive device; and
wherein said lottery player interactive device is operable to enable a lottery player to purchase at least one of said lottery tickets.

52. The system of claim 51, wherein said system further comprises at least one of said lottery player interactive device; and wherein a particular one of said least one lottery player interactive device comprises a lottery web site device.

53. The system of claim 51, wherein said system further comprises at least one of said lottery player interactive device; and wherein a particular one of said least one lottery player interactive device comprises a lottery point of sale device.

54. The system of claim 51, wherein said system further comprises at least one of said lottery player interactive device; and wherein a particular one of said least one lottery player interactive device comprises a lottery wireless device.

55. The system of claim 51, wherein said system further comprises at least one of said lottery player interactive device; and wherein a particular one of said least one lottery player interactive device comprises a lottery television device.

56. The system of claim 51, wherein said particular one of said at least one lottery player interactive device is operable to enable a lottery player to select an auto-purchase feature.

57. The system of claim 51, wherein said particular one of said at least one lottery player interactive device is operable to enable a lottery player to select an auto-deposit of winnings feature.

58. The system of claim 51, wherein said particular one of said at least one lottery player interactive device is operable to enable a lottery player to select an auto-notification feature.

59. The system of claim 51, wherein said particular one of said at least one lottery player interactive device is operable to enable a lottery player to select a customized gift pack feature.

60. The system of claim 51, wherein said particular one of said at least one lottery player interactive device is operable to enable a lottery player to select a prize money designation feature.

61. The system of claim 51, wherein said particular one of said at least one lottery player interactive device is operable to enable a lottery player to select a lottery pool feature.

62. The system of claim 61, wherein said lottery pool feature is operable to enable said lottery player to select an open lottery pool creation feature.

63. The system of claim 61, wherein said lottery pool feature is operable to enable said lottery player to select a closed lottery pool creation feature.

64. The system of claim 61, wherein said lottery pool feature is operable to enable said lottery player to select a lottery pool third party proceeds designation feature.
